(19) United States
(12) Patent Application Publication
(10) Pub. No.: US 2007/0079279 A1
(43) Pub. Date: Apr. 5, 2007

(54) Embedded device with software registry

(76) Inventors: David Gordon, Basingstoke (GB); Nicholas John Jones, Wokingham (GB)

Correspondence Address: RATNERPRESTIA, P.O. BOX 980, VALLEY FORGE, PA, 19482, US

(21) Appl. No.: 10/562,506

(22) PCT Filed: Jun. 21, 2004
(86) PCT No.: PCT/GB04/02671

§ 371 Date: Dec. 23, 2005

(30) Foreign Application Priority Data
Jun. 23, 2003 (GB) 0314616.4

(51) Int. Cl. G06F 9/44

(52) U.S. Cl. 717/100

(57) ABSTRACT

A control device for electrical or electronic equipment, usually embedded, has a patch registry storing details of software fixes or “patches” that have been installed.

The present invention relates to control devices of the kind that are embedded in electrical and electronic apparatus. The invention has been developed for application to mobile telephones but is equally applicable to a wide range of equipment with embedded devices from vehicles to washing machines.

### BACKGROUND

Software errors in a high volume commodity product (such as a mobile phone handset) can be very expensive to repair, involving a product recall, software reprogramming, and then re-issue of the product, not to mention such additional items as replacements-under-guarantee and loss of reputation and customer confidence. Clearly, a mechanism is needed where software upgrades and fixes, known as “patches”, can be installed, uninstalled and managed on a target device without recall of that target device and consequently with little impact to the user of the device. Additionally, the uses to which such a device can be put vary from user to user, and it may be necessary to install, uninstall and manage new software modules in addition to those already resident on the device.

Once such a mechanism is in place, the patches and updates installed on the handset may be managed, both locally on the handset User Interface (if present) or remotely over a communications link.

It is known for a device with large hard disc memory capacity, such as a personal computer, to have a program registry stored on the hard disc. This registry may include information relating to any programs or software upgrades recently installed on the computer.

U.S. Pat. No. 6,434,744 shows a system for a computer in which patching operations are performed on particular applications and a configurable database is updated with patching information. In a system of this type, the application of a patch is performed at run-time when applications and their patches previously stored on hard disc are copied to volatile memory for use. Such an arrangement is not suitable for an embedded device such as that contained in a mobile telephone where power consumption has to be minimised and memory space conserved.

Hitherto, when a software modification is required on a mobile telephone (or other device/appliance having an embedded system), for example during a product recall, it would be usual to rewrite the whole of the device software, for example by “reflashing” a flash memory. A separate management system might store information identifying which software versions have been installed on which devices, for example to avoid repetition and to aid future problem analysis.

The present invention provides a control device as defined in annexed claim 1. Preferred features of the device are described in the subsidiary claims. The installed programs may include equipment operating programs as well as universal applications such as calendars and calculators.

By contrast with the prior art computer system described above, in a control device such as for a mobile telephone, the operating programs are stored in and run from non-volatile memory rather than having to be transferred to volatile memory at run time. In order to conserve memory space, in a control device according to the invention a new patch is used to modify the code to which it relates instead of being stored separately, and the registry simply contains a patch descriptor. There is then no need for the patch code itself to be separately stored.

An example of a patch registry suitable for use in a control device according to the invention, sometimes called a “target device”, will now be described by way of example only and with reference to the accompanying drawings in which:

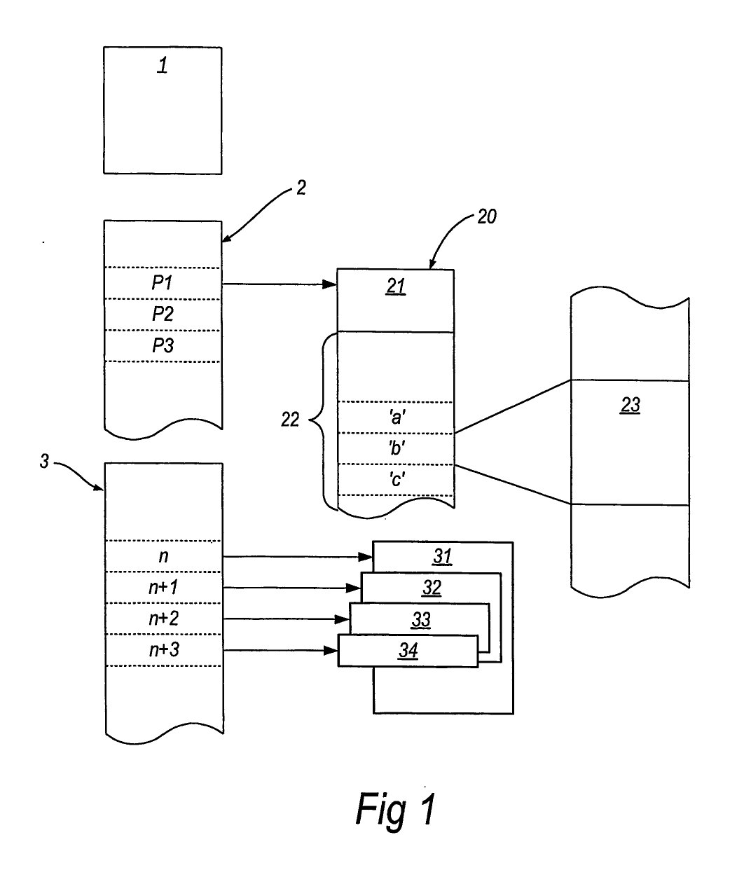

FIG. 1 is a block diagram over-view of a patch registry; and

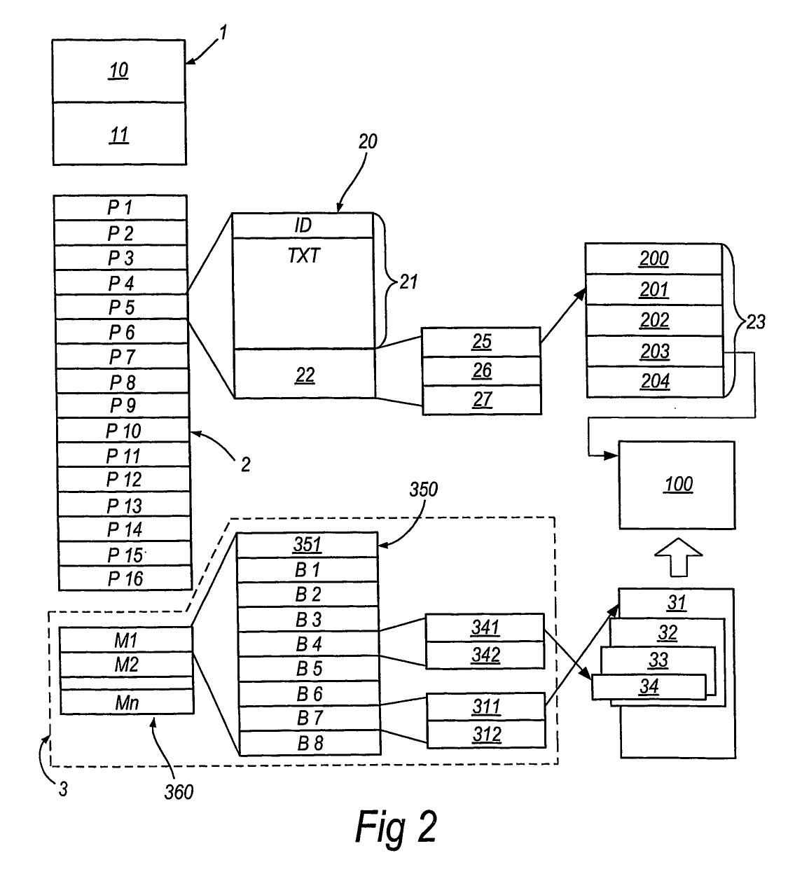

FIG. 2 is a more detailed block diagram showing an example of the data structures that may be used in the patch registry.

A device according to the present invention typically consists of a self-contained device having one or more computing components each with processor, memory and non-volatile program storage of limited size. These may not be “self contained” units and processors may share memory space. The device may also contain network connectivity to enable access to a server system; or facility to allow network connectivity to a server system, and may contain a removable storage device, for example an SD card.

The patch registry will contain information about patch files (not the patch code itself), installed patches and software updates. A patch file is the means of delivery of one or more patches to the device, and consists of a collection of data which contains information sufficient to allow a device to modify its program memory. A patch file may contain information about one or more patches, each of which may be composed of information about one or more changes to be made to the program memory of the target device. The patch file must be transferred to the target device before any modifications can occur. The patch file is used by a system (e.g. program) resident on the target device.

Some of the characteristics of the device impose particular requirements on the design of the patch registry. These characteristics are:
Limited memory space both for persistent (i.e. that which remains present over a power off-on cycle) storage of program and configuration information, and also non-persistent (volatile) storage of other information.
The main persistent storage medium, usually Flash memory, requires specialised processing in order to make modifications to its contents.
The file system uses memory as its storage medium rather than being disk-based, and in a memory-constrained device this file system will consequently have limited storage capacity.
The program of each computing element typically runs directly from the persistent storage of the device, unlike larger desktop computing devices that store their programs on a backup store (usually a hard disk) and then load the programs that are desired to be run into volatile (non-persistent) storage during their start up sequence.
It may not be commercially acceptable that the mobile device be restarted as a consequence of the changes being applied.

The requirements imposed on the design of the patch registry by these characteristics are:
The information stored describing the changes must be particularly detailed, though must at the same time be optimised to consume a minimal amount of storage.
The Patch system must allow recovery from a power failure during an installation or uninstallation.

The mechanism proposed is extendable to be used for new software installation, for upgrade or bug fixing, or installation of new functionality.

The following describes how information relating to patches is installed in the program storage of a target device. The method of distribution and installation of a patch is not described here, but may use the network connectivity or the removable storage device.

Referring now to FIG. 1, the patch registry will include at least status and progress information 1, to be described in more detail below, patch list 2 and a list of unused program storage blocks 3. The patch list 2 will usually contain a list of patch identifiers such as P1, P2 . . . etc. Typically, for each patch, the registry will contain a record 20 of information relating to the patch including patch descriptor 21 and a list of changes being effected by the patch, a, b, c etc. For each change, a, b, c etc there will be a change descriptor 23 containing further details of the change. For each unused program storage block n, n+1, n+2, n+3 there is a corresponding information block 31, 32, 33, 34 to be described in more detail below.

In general a patch consists of one or more individual changes to the program memory of a target device, replacing “faulty code” or “old code” with “repaired” code or “new code”. Each of these changes is therefore made to non-volatile storage.

The patch system installs patches on the Target Device in two ways. For each change either the faulty program code is overwritten by the repair code, or the repair code is installed in an unused area of program memory and program flow is directed to this area when required and back to the main program as necessary. In both cases, a record of information about the identity and location of the installed patch is created and maintained consisting of items P1 and 20 to 23 of FIG. 1. A list of unused program storage for each processing element may also be manipulated items 3 and 31-34 of FIG. 1.

From time to time it may be necessary to uninstall or remove patches from the Target Device. The previously described record of information 2 is used to uninstall the changes and to return any areas of program memory that were used back to the list of unused program storage 3. Once the unused areas have been returned the information about the patch is removed from the Registry.

Lastly, the Server System may interrogate the Target Device to determine what patches are installed and what capacity for further patches is available. This information may also be presented on demand through the user interface of the Target Device (not shown). The information used to respond to such requests is derived from information saved in the Patch Registry.

In all these cases, it is necessary for the Target Device to retain information about the patches installed in it, and to maintain information about the remaining unused program memory. The patch registry is the means by which this information is retained.

An exemplary data structure of the patch registry is shown in more detail in FIG. 2. Any suitable storage format such as text, binary, XML may be used and will not be described in detail herein.

Status and progress information block 1 includes two elements, namely element 10 indicating the overall status of the registry, e.g. a counter value implemented at each update, and patch installation status information block 11 containing information about the progress of the installation of any particular patch. Patch descriptor information block 21 contains a simple patch identifier (ED) as well as a text (TXT) descriptor element for presentation to the user by the device man-machine interface. The list of modified code descriptor elements 22 will contain, as well as the simple list illustrated in FIG. 4, indicated by “head” item 25 and “tail” item 26, a count of the number of elements 27. Each change descriptor 23 will include item 200 identifying the processing element to which the patch; is to be applied, item 201 containing the address of the faulty code to be repaired, item 202 containing the size of the faulty code to be repaired, item 203 containing the address of the repair and item 204 containing the size of the repair. The executable code of the patch, item 100 will be at the address indicated in item 203.

The unused program storage may include literally “empty” memory space, erased storage, storage that is simply deallocated and not erased in which case the contents are not useful, and any other space that has no anticipated code use. Each list of unused program memory blocks holds blocks in size order, smallest first, and may contain a reference or pointer to each unused program memory block in the list.

For each unused program storage block 31 to 34, the data structure will include the block address and block size. Two of these are shown, namely block address 341 for block 34, block size 342 for block 34, block address 311 for block 31 and block size 312 for block 31. Each block B1, B2, B3 etc will be held in the list 350 including a header item 351. The block list will be an array associated with a particular processing element M1, M2, . . . Mn identified in list 360.

It will be appreciated from the foregoing that the patch registry satisfies the following requirements:
Record details of all patches already installed for interrogation remotely by a Server System.
Record details of all patches already installed for interrogation locally by management software on the Target Device.
For each completed change, identify the computing component(s) to which the change was applied.
Allow identification of attempts to send duplicate patches perhaps by retaining an ID for each installed patch.
Allow identification of address clashes between any installed patch and a new patch.
Hold information about the unused program storage remaining for each computing element, and allow interrogation of same to facilitate patch installation and removal and for interrogation by the Server System or management software on the Target Device. The unused program storage is typically composed of a number of individual blocks. The Registry lists these in a manner which facilitates efficient searching when installing a new patch.
Record details of patches being installed or uninstalled, to allow recovery after a power failure.

Since the Patch Registry is contained in non-volatile storage, and contains details about the patches installed over a particular version of the software of the target device, it should be noted that the patch registry must be rendered to an empty state when a new version of software is installed on the target device.

1. A control device for electrical or electronic equipment, the device having processing means and non-volatile memory means, the non-volatile memory means having installed programs executable by the processing means directly from the non-volatile memory means, each program being made up of processing elements at least one of which can be modified or upgraded by the Installation of a patch, wherein:
a part of the memory means is used as a patch registry containing a list of patch descriptor elements, and
the processing means is arranged to install a new patch by modifying the program processing element to which It relates and storing a catch descriptor element for the patch in the patch registry, each atch descriptor element containing a list of modified code descriptor elements identifying the processing element to which the catch has been applied.

2. A device as claimed in claim 1 in which the patch registry includes information relating to progress of the installation of the new patch.

3. A device as claimed In claim 1 or 2 in which the patch registry includes a list of unused program memory blocks for each processing element,

4. A device as claimed in claim 3 In which, on installation of the new patch, unused program memory in the list is used to extend the patch registry to contain information relating to the new patch.

5. A device as claimed in claim 1 or 2 in which each patch descriptor element contains a text description of the patch configured to be presented to a user interface.

6.-7. (canceled)

8. A device as claimed in claim 1 or 2 in which the modified code descriptor elements identify a start address of a faulty code block in the processing element.

9. A device as claimed in claim 1 or 2 in which the modified code descriptor elements identify a number of bytes of faulty code in the processing element being repaired by the patch.

10. A device as claimed in claim 1 or 2 in which the modified code descriptor elements include a start address of the memory area used for repaired code contained in the patch.

11. A device as claimed in claim 1 or 2 in which the modified code descriptor elements contain information in the form of binary flags describing how the repaired code contained in the patch was installed.

12. A method of modifying programs installed in a control device for electrical or electronic equipment, the control device having processing means and non-volatile memory means, the non-volatile memory means having installed programs executable by the processing means directly from the non-volatile memory means and each program being made up of processing elements, the method comprising:
a) downloading to the control device a new patch from an external source containing code for modifying one of the program processing elements,
b) installing the new patch by modifying the one program processing element to which it relates in the non-volatile memory; and
c) storing a descriptor element for the new patch in a separate part of the non-volatile memory designated as patch registry in which the patch descriptor element is configured to contain a list of modified code descriptor elements identifying the one program processing element to which the new patch has been applied.

13. A method as claimed in claim 12 including, during step b), the step of storing, in the patch registry, information relating to progress of the installation of the new patch.

14. A method as claimed in claim 12 or 13 additionally comprising the step of storing in the patch registry a list of unused memory blocks for each of the processing elements.

15. A method as claimed in claim 14 in which, on installation of the new patch, the patch registry is extended using unused memory and information relating to the new patch is stored In said unused memory added to the patch registry.

16. A method as claimed in claim 12 or 13 further including the step of configuring each patch descriptor element to contain a text description of the patch which is configured to be presented to a user interface.

17.-18. (canceled)

19. A method as claimed in claim 12 or 13, in which the modified code descriptor elements are configured so as to identify a start address of a code block in the one processing element to be modified.

20. A method as claimed in claim 12 or 13 in which the modified code descriptor elements identify respective numbers of bytes of code in the one processing element being modified by the patch.

21. A method as claimed in claim 12 or 13, in which the modified code descriptor elements include a start address of a memory area used for the modified code contained in the patch.

22. A method as claimed in claim 12 or 13 in which the modified code descriptor elements contain information in the form of binary flags describing how repaired code contained in the patch was installed.

23. A method as claimed in claim 12 or 13, in which step (b) comprises overwriting code in the one processing element with code contained in the patch.

24. A method as claimed in claim 12 or 13 in which step (b) comprises installing the patch code in a selected unused part of the non-volatile memory and diverting program flow to the selected part of the non-volatile memory and back again thereby bypassing code in the unmodified processing element.
